(19) United States
(12) Patent Application Publication
(10) Pub. No.: US 2024/0343872 A1
(43) Pub. Date: Oct. 17, 2024

(54) FLUORINE-FREE SUPERHYDROPHOBIC SURFACES, METHODS OF MAKING AND USES THEREOF

(71) Applicant: McMaster University, Hamilton (CA)

(72) Inventors: Tohid F. Didar, Hamilton (CA); Leyla Soleymani, Oakville (CA); Liane Ladoucheur, Hamilton (CA)

(73) Assignee: McMaster University, Hamilton, ON (CA)

(21) Appl. No.: 18/683,559

(22) PCT Filed: Aug. 17, 2022
(86) PCT No.: PCT/CA2022/051249

§ 371 Date: Feb. 14, 2024

Related U.S. Application Data
(60) Provisional application No. 63/260,371, filed on Aug. 18, 2021.

(51) Int. Cl. C08J 7/12; B05D 3/14; B05D 5/06; C08J 7/06; C09D 5/14; C09D 5/16

(52) U.S. Cl. CPC C08J 7/123; B05D 3/144; B05D 5/062; C08J 7/065; C08J 7/08; C09D 5/14; C09D 5/1681; B05D 2201/02; C08J 2323/30

(57) ABSTRACT

This disclosure relates to superhydrophobic materials and/or surfaces comprising a shrinkable polymer substrate and at least one polysiloxane layer, wherein the materials and/or surfaces comprise microscale wrinkles and nanoscale features that form hierarchical structures. Methods of making and uses thereof are also disclosed herein.

### CROSS-REFERENCE TO RELATED APPLICATIONS

The present application claims the benefit of priority to U.S. provisional patent application Ser. No. 63/260,371 filed on Aug. 18, 2021, the contents of which are incorporated herein by reference in their entirety.

### FIELD

The present disclosure relates to surface engineering, and in particular, to fluorine-free superhydrophobic surfaces and methods of making and uses thereof.

### BACKGROUND

Surface contamination plays a major role in spread and transmission of pathogens. Whether in healthcare, food supply chain or in public spaces, the risk for pathogen spread through fomites has been extensively demonstrated. In the healthcare system, a major risk is presented by healthcare-associated infections (HAIs). For instance, a serious threat is posed by Carbapenem-Resistant Enterobacteriaceae (CRE), a family of pathogens which are resistant to nearly all antibiotics. Transmission of pathogens by healthcare workers through direct contact with infected patients or indirectly by touching contaminated surfaces in patient areas has been estimated to account for 20 to 40% of HAIs. This highlights the importance of designing repellent surfaces that resist contamination or biofouling. While many efforts have been made to tackle this problem, proposed solutions face numerous limitations including cost-prohibitive production methods, environmentally unfriendly materials or incompatibility with high-touch applications.

To achieve repellent properties, researchers aim to create superhydrophobic surfaces characterized by contact angles >150 degrees and sliding angles <10 degrees. Strategies for manufacturing are often bioinspired, such as physical modifications to add roughness inspired by the multiscale texture found on lotus leaves and butterfly wings. This increased roughness provides the basis for Cassie-Baxter or Wenzel wetting states. Conventional techniques to accomplish roughness include etching, electrochemical deposition, templating, spray coatings, application of nanoparticles such as gold or silica, and sol-gel processes. To closely replicate the lotus effect, researchers commonly employ a series of these modifications to introduce hierarchical structuring.¹⁻³ By implementing multiple-step approaches, both micro- and nano-scale features are established on surfaces, which can be employed for biorepellency.^{1,4,5} While these techniques have demonstrated success, it is often difficult to produce these surfaces on a large scale due to manufacturing limitations and prohibitive costs of reagents involved.

Alternatively, chemical modification can be employed to decrease the surface free energy (SFE) of manufactured surfaces, using techniques such as chemical vapour deposition (CVD), liquid phase deposition (LPD), plasma, self-assembly and solution immersion. These approaches frequently utilize silane molecules to form mono- or multilayer coatings that decrease SFE and can be paired with physical modification to demonstrate superhydrophobic properties. The silane molecules employed contain reactive functional groups, such as chlorine, which facilitate self-assembled coatings through surface-initiated condensation reactions and allow ease and control of fabrication. Often, fluorocarbons constitute the backbone of these chemicals, such as those included in trichloro(1H, 1H, 2H, 2H-perfluorooctyl) silane (TPFS) and 1H, 1H, 2H, 2H-perfluorodecyltrichlorosilane (PFDTS). However, these chemicals present potentially serious environmental risks. Long-term studies have demonstrated the toxic effects of long-chain (C₉-C₂₀) fluorocarbons and their precursors in mammals, as well as the persistence of these and shorter chains in the environment leading to a bioaccumulation in plants, animals, and humans. For this reason, research has turned to more environmentally friendly modification strategies.

Growth of polysiloxane nanostructures to convey superhydrophobicity has offered a more environmentally friendly approach, first investigated in 2006 by Artus et al.⁶ By utilizing trichlorosilane molecules with short, one or two carbon chains and without fluorine groups, coatings have been achieved through both CVD and LPD.⁷⁻⁹ These structures demonstrate a promising route for inducing surface roughness, leading to superhydrophobicity and self-cleaning properties, which has more recently been established for three-carbon chain trichlorosilanes as well.^{10,11} Few reports of pathogen repellency for these surfaces exist, likely due to the conflicting results that have been seen. For example, when coated on glass, polysiloxane nanofilaments and rod structures exhibited varying behaviour for static versus dynamic conditions, based on the type of bacteria tested.¹² Effectiveness was also dependent on the architecture of the coating, which research has demonstrated depends on humidity level, temperature, and substrate.

To address the challenges with pathogen repellency that polysiloxane structured surfaces experience, lubricant has been employed. When combined with a silicone oil lubricant layer to imitate the slippery properties of the pitcher plant, polysiloxane nanofilaments were shown to prevent bacterial adhesion and suppress thrombosis on medical devices such as catheters and splints. Slippery, liquid-infused surfaces (LIS) represent an exceptional alterative surface modification method with self-cleaning properties. Lubricants are added to a chemically or structurally modified surface which is designed to trap a lubricant layer. LIS have demonstrated biorepellent properties with many applications in closed spaces or under flow, using bacteria, viruses and complex biofluids. Limitations to these surfaces exist, however, as their liquid-infused nature precludes use for high-touch surfaces since direct contact with the surface would transfer lubricant residue. Additionally, many of the lubricants employed are quite volatile, making the implementation open-air surfaces impractical.

### SUMMARY

The present disclosure provides a material comprising a shrinkable polymer substrate and at least one polysiloxane layer on a surface layer of the substrate, wherein the material comprises microscale wrinkles and nanoscale features that form hierarchical structures on a surface of the material, and wherein the material exhibits superhydrophobic properties.

In some embodiments, the material comprises at least one polysiloxane layer on each of a plurality of surfaces of the substrate.

In some embodiments, the shrinkable polymer substrate comprises polystyrene, polyolefin, polyethylene, polypropylene, and other shrinkable polymers or combinations and copolymers thereof.

In some embodiments, the shrinkable polymer substrate is polyolefin.

In some embodiments, the shrinkable polymer substrate is bi-directionally strained.

In some embodiments, the nanoscale features comprise filament and/or rod-shaped structures.

In some embodiments, the at least one polysiloxane layer forms the nanoscale features.

In some embodiments, the at least one polysiloxane layer is formed using a silane.

In some embodiments, the at least one polysiloxane layer is formed using one or more compounds of the Formula II:

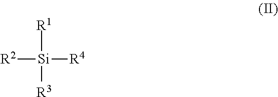

wherein R¹, R² and R³ are each independently a hydrolysable group; and R⁴ is C₁₋₆ alkyl.

In some embodiments, the at least one polysiloxane layer is formed using n-propyltrichlorosilane.

In some embodiments, the at least one polysiloxane layer is not formed using a fluorosilane.

In some embodiments, the material has a water static contact angle of more than about 150°, about 151°, about 152°, about 153°, about 155°, about 165°, about 170° or about 175°.

In some embodiments, the material has a water sliding angle of less than about 5°. In some embodiments, the material has a water sliding angle of less than about 1°.

In some embodiments, the material possesses antibacterial or antifouling properties.

In some embodiments, the material exhibits repellency to biological fluids.

In some embodiments, the material exhibits repellency to blood.

In some embodiments, the material exhibits repellency to liquids comprising biospecies.

In some embodiments, the material exhibits repellency to bacteria and biofilm formation.

The present disclosure also provides a device or article comprising the material disclosed herein.

In some embodiments, the material is on a surface of the device or article. In some embodiments, the material forms a surface of the device or article.

The present disclosure also provides a method of preparing a material having a surface with hierarchical structures, the method comprising:
a) providing a shrinkable polymer substrate,
b) activating a surface layer of the substrate by oxidation,
c) depositing at least one polysiloxane layer on the activated surface layer at substantially consistent relative humidity, and
d) treating the substrate under conditions to form microscale wrinkles and nanoscale features to obtain the material,
   wherein the material exhibits superhydrophobic properties.

The present disclosure also provides a method of preparing a material having a surface with hierarchical structures, the method comprising:
a) activating a surface layer of a shrinkable polymer substrate by oxidation,
b) depositing at least one polysiloxane layer on the activated surface layer at substantially consistent relative humidity, and
c) treating the substrate under conditions to form microscale wrinkles and nanoscale features to obtain the material,
   wherein the material exhibits superhydrophobic properties.

According to another aspect of the present disclosure, provided herein is a method of preparing a material having a surface with hierarchical structures, the method comprising:
a) activating a shrinkable polymer substrate by oxidation,
b) depositing at least one polysiloxane layer on the shrinkable polymer substrate at substantially consistent relative humidity, and
c) treating the substrate under conditions to form microscale wrinkles and nanoscale features to obtain the material,
   wherein the material exhibits superhydrophobic properties.

In some embodiments, activating the surface layer of the substrate comprises introducing hydroxyl groups, in or on the substrate.

In some embodiments, activating the surface layer of the substrate comprises plasma treatment.

In some embodiments, the plasma treatment is for a time of about 30 seconds to about 10 minutes, or about 2 minutes to about 7 minutes, or about 3 minutes to about 5 minutes.

In some embodiments, the shrinkable polymer substrate provided in step a) is bi-directionally strained. In some embodiments, the method further comprises bi-directionally straining the shrinkable polymer substrate. In some embodiments, the bi-directionally straining of the shrinkable polymer substrate is before the activating.

In some embodiments, the shrinkable polymer substrate comprises polystyrene, polyolefin, polyethylene, polypropylene, and other shrinkable polymer or combinations and copolymers thereof. In some embodiments, the shrinkable polymer substrate is polyolefin.

In some embodiments, the relative humidity is substantially maintained at about 45% and about 65%, or about 50% to about 60%, or about 55%.

In some embodiments, the relative humidity is substantially maintained for about 4 hours to about 30 hours, or about 5 hours to about 24 hours, or about 6 hours. In some embodiments, the relative humidity is substantially maintained for the time to deposit the at least one polysiloxane layer. In some embodiments, the at least one polysiloxane layer is formed using n-propyltrichlorosilane.

In some embodiments, the microscale wrinkles and the nanoscale features are formed by heat-shrinking the substrate.

Other features and advantages of the present disclosure will become apparent from the following detailed description. It should be understood, however, that the detailed description and the specific examples, while indicating embodiments of the disclosure, are given by way of illustration only and the scope of the claims should not be limited by these embodiments, but should be given the broadest interpretation consistent with the description as a whole.

### DRAWINGS

Certain embodiments of the disclosure will now be described in greater detail with reference to the attached drawings in which:

FIG. 1 shows hierarchically structured superhydrophobic n-PTCS surfaces in exemplary embodiments of the disclosure: a) fabrication process using a customized humidity chamber; b) SEM images of planar and hierarchical samples at ideal incubation time of 6 hrs-(scale bar represents 40 μm for left image, 100 μm for right image and 4 μm for both insets); c) side view SEM image of the hierarchical surfaces shown in b)—raw edge of sample was imaged using 45° tilted stub and 45° tilt of stub to produce a side view (scale bar represents 100 μm).

FIG. 2 shows contact and sliding angle comparison for 3 min and 5 min plasma treatments in exemplary embodiments of the disclosure (error bars illustrate the standard deviation for contact angles).

FIG. 3 shows characterization and optimization of the hierarchical PO surfaces in exemplary embodiments of the disclosure: a) optimization of incubation with n-PTCS characterized using contact and sliding angle data-unless otherwise stated, contact angle measurement used a 2 μL droplet while sliding angle measurements were taken with a 5 μL droplet (error bars represent the standard deviation calculated across a minimum of 3 replicate measurements); b) frame-by-frame images of water droplet bouncing on hierarchical surface-5 μL water droplet shows two bounces, with decreasing height when dropped from ˜10 mm height; c) temperature stability tests of hierarchical n-PTCS surfaces stored for 24 hrs at −20° C. and 37° C., with contact and sliding angle measurements performed before and after to assess performance; d) stability in ethanol of hierarchical n-PTCS submerged in 100% ethanol for 1.5 hrs with contact angle measured before and after incubation; e) Sonication in ethanol stability test using contact angle data for hierarchical surface subjected to a series of sonication treatments in ethanol; f) long term stability of surfaces stored at room temperature in petri dishes tested 3, 4 and 5 months after manufacturing showing no change in contact and sliding angles.

FIG. 4 shows SEM images of planar and shrunk samples at various incubation times (scale bars are 10 μm for large images and 1 μm for insets) in exemplary embodiments of the disclosure.

FIG. 5 shows contact and sliding angle characterization of planar and shrunk samples with silicone oil of varying densities in exemplary embodiments of the disclosure.

FIG. 6 shows evaluation of blood repellency of hierarchical n-PTCS surfaces in exemplary embodiments of the disclosure: a) comparative summary of contact angle and sliding angle measurements for water and blood; b) optical images of residue left by 5 μL droplets of citrated human whole blood droplets introduced to the surface for the indicated time; c) quantitative evaluation of blood droplet staining of images of samples shown in b) evaluated using ImageJ to obtain integrated density values-significant reduction was calculated using a two-way ANOVA test and demonstrated across multiple groups, indicated here with **(P=0.01), ***(P=0.001) and ****(P=0.0001); error bars represent standard deviation; d) relative absorbance values from whole blood staining normalized to the control condition, planar PO-optical images of a sample surface are shown above each condition on the plot; significance was tested with a one-way ANOVA and is indicated here with **(P=0.01), ***(P=0.001) and ****(P=0.0001).

FIG. 7 shows evaluation of the bacterial repellency of hierarchical n-PTCS surfaces in exemplary embodiments of the disclosure: a) fluorescent images of surfaces after bacterial transfer from agar stamps, using surfaces stamped with green fluorescent protein tagged E. coli K-12 and imaged using the Amersham Typhoon imaging system; b) quantitative evaluation of fluorescence images using intensity/area (values were calculated using ImageJ software); c) direct quantification of bacteria transferred from agar stamps from samples of bacteria from each condition plated and incubated overnight to allow growth (plots use log scale)-error bars represent the standard error of the mean; one-way ANOVA tests were used to evaluate significance, indicated here using **(P=0.01) and ***(P=0.001).

### DETAILED DESCRIPTION

### I. Definitions

Unless otherwise indicated, the definitions and embodiments described in this and other sections are intended to be applicable to all embodiments and aspects of the present disclosure herein described for which they are suitable as would be understood by a person skilled in the art. It is also to be understood that the terminology used herein is for the purpose of describing particular aspects only and is not intended to be limiting.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies. In addition, all ranges given herein include the end of the ranges and also any intermediate range points, whether explicitly stated or not.

As used in this disclosure, the singular forms “a”, “an” and “the” include plural references unless the content clearly dictates otherwise.

In embodiments comprising an “additional” or “second” component, the second component as used herein is chemically different from the other components or first component. A “third” component is different from the other, first, and second components, and further enumerated or “additional” components are similarly different.

The term “and/or” as used herein means that the listed items are present, or used, individually or in combination. In effect, this term means that “at least one of” or “one or more” of the listed items is used or present.

The abbreviation, “e.g.” is derived from the Latin exempli gratia and is used herein to indicate a non-limiting example. Thus, the abbreviation “e.g.” is synonymous with the term “for example.” The word “or” is intended to include “and” unless the context clearly indicates otherwise.

The term “room temperature” as used herein refers to a temperature in the range of about 20° C. and about 25° C.

The term “wrinkling” as used herein refers to any process for forming wrinkles in a material.

The term “wrinkles” as used herein refers to microscale to nanoscale folds.

The term “hierarchical structure” as used herein refers to both microscale and nanoscale structural features. For example, hierarchical structure on a surface of a material refers to the microscale and nanoscale structural features on the surface of the material.

The term “superhydrophobic” as used herein in respect to a material refers to a material that exhibits very hydrophobic (low wettability for water and other polar liquids) properties. Such superhydrophobic materials with very high water contact angles, such as above 150°, are often regarded as “self-cleaning” materials, as polar contaminants will typically bead up and roll off the surface.

The terms “shape memory polymer”, “shrinkable polymer” and “heat-shrinkable polymer” as used herein refers to a pre-strained polymeric material.

The term “alkyl” as used herein, whether it is used alone or as part of another group, refers to straight or branched chain, saturated alkyl group, that is a saturated carbon chain that contains substituents on one of its ends. The number of carbon atoms that are possible in the referenced alkyl group are indicated by the numerical prefix “Cₙ₁₋ₙ₂”. For example, the term C₁₋₆alkyl means an alkyl group having 1, 2, 3, 4, 5 or 6 carbon atoms.

The term “halo” as used herein refers to a halogen atom and includes F, Cl, Br and I.

The term “hydroxyl” as used herein refers to the functional group OH.

The term “suitable” as used herein means that the selection of the particular compound or conditions would depend on the specific synthetic manipulation to be performed, and the identity of the molecule(s) to be transformed, but the selection would be well within the skill of a person trained in the art. All process/method steps described herein are to be conducted under conditions for the reaction to proceed to a sufficient extent to provide the product shown. A person skilled in the art would understand that all reaction conditions, including, for example, reaction solvent, reaction time, reaction temperature, reaction pressure, reactant ratio and whether or not the reaction should be performed under an anhydrous or inert atmosphere, can be varied to optimize the yield of the desired product and it is within their skill to do so.

It will be understood that any component defined herein as being included may be explicitly excluded by way of proviso or negative limitation, such as any specific compounds or method steps, whether implicitly or explicitly defined herein.

### II. Compositions and Methods of the Disclosure

Disclosed herein is a flexible hierarchical surface coating without fluorine or lubricant. This surface is made using a simple, affordable, and fluorine-free method to manufacture superhydrophobic, biorepellent surfaces with wrinkled topography that achieves performance equivalent to lubricant-infused surfaces. This was achieved by combining polysiloxane nanostructuring and wrinkling of thermoplastic polymers to attain a hierarchical, stable surface.

Herein, in embodiments, these hierarchical surfaces were prepared through growth of polysiloxane nanoscale features, such as nanostructures using n-propyltrichlorosilane (n-PTCS) via CVD treatment on a thin thermoplastic material, such as a shape memory polymer substrate, such as polyolefin (PO), followed by heat shrinking to wrinkle the stiff n-PTCS nanostructured layer, generating micro-wrinkles with integrated n-PTCS nanostructures.

The developed surfaces and/or coatings demonstrated superhydrophobic properties to achieve liquid and pathogen repellency, as well as anti-biofouling properties without the use of lubricants. These hierarchical surfaces demonstrated high reduction in transmission of bacteria, showing their potential as antimicrobial coatings to mitigate the spread of infectious diseases, and high reduction in blood staining after incubation with human whole blood with the advantage of being lubricant-free for usability in high-touch and open-air settings. Thus, the final product is a fluorine-free, flexible, superhydrophobic, biorepellent surface with demonstrated capability to repel bacteria and complex biofluids such as human whole blood.

Employing the advantages of this facile, low-cost, and environmentally safe production method, herein is produced a flexible, superhydrophobic hierarchical surface with strongly repellent properties that may be used generally in high-touch, open-air settings and further in the healthcare and food industries, based on their repellency to pathogens and stability in cleaning agents such as ethanol. Applications of these surfaces in more long-term biomedical applications, such as catheters and implants, and as cell-culture platforms are also possible.

Accordingly, provided herein is a material comprising a shrinkable polymer substrate and at least one polysiloxane layer, wherein the material comprises microscale wrinkles and nanoscale features that form hierarchical structures, and wherein the material exhibits superhydrophobic properties.

Also provided herein is a material comprising a shrinkable polymer substrate and at least one polysiloxane layer on a surface layer of the substrate, wherein the material comprises microscale wrinkles and nanoscale features that form hierarchical structures on a surface of the material, and wherein the material exhibits superhydrophobic properties.

In some embodiments, the material comprises at least one polysiloxane layer on each of a plurality of surfaces of the substrate.

In some embodiments, the shrinkable polymer substrate comprises polystyrene, polyolefin, polyethylene, polypropylene, and other shrinkable polymer or combinations and copolymers thereof. In some embodiments, the shrinkable polymer substrate is polyolefin. In some embodiments, the substrate is a thin flexible film of polyolefin.

In some embodiments, the shrinkable polymer substrate is bi-directionally strained.

In some embodiments, the microscale wrinkles are fabricated from wrinkling the surface layer of the shrinkable polymer substrate.

In some embodiments, the nanoscale features comprise filament and/or rod-shaped structures.

In some embodiments, the at least one polysiloxane layer forms the nanoscale features.

In some embodiments, the at least one polysiloxane layer is formed using a silane.

In some embodiments, the at least one polysiloxane layer is formed using one or more compounds of the Formula II:

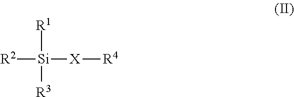

wherein R¹, R² and R³ are each independently a hydrolysable group; X is a single bond; and R⁴ is C₁₋₆alkyl.

In some embodiments, the at least one polysiloxane layer is formed using one or more compounds of the Formula II:

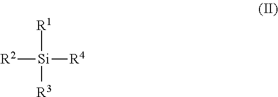

wherein R¹, R² and R³ are each independently a hydrolysable group; and R⁴ is C₁-6alkyl.

The hydrolysable group is any suitable hydrolysable group, the selection of which can be made by a person skilled in the art. In some embodiments, R¹, R² and R³ are independently halo. In some embodiments, R¹, R² and R³ are all Cl.

In some embodiments, R⁴ is C₁₋₆alkyl. In some embodiments, R⁴ is C₁₋₃alkyl.

In some embodiments, the at least one polysiloxane layer is formed using a silane. Suitable examples of the silane include but are not limited to, trichloro(methyl) silane, trichloro(ethyl) silane, and/or n-propyltrichlorosilane. In some embodiments, the at least one polysiloxane layer is formed using n-propyltrichlorosilane.

In some embodiments, the at least one polysiloxane layer is not formed using a fluorosilane.

In some embodiments, the material has a water static contact angle of more than about 150°, about 150°, about 151°, about 152°, about 153°, about 155°, about 165°, about 170° or about 175°. In some embodiments, the material has a water static contact angle of about 150° to about 165°.

In some embodiments, the material has a water sliding angle of less than about 5°, less than about 4°, less than about 3°, less than about 2° or less than about 1º. In some embodiments, the material has a water sliding angle of less than about 1º.

In some embodiments, when interfacing these materials with hierarchical surfaces with blood or bacterial contaminants, it was observed that their superhydrophobicity can be translated to better anti-biofouling properties. In some embodiments, the material possesses antibacterial or antifouling properties.

In some embodiments, the material exhibits repellency to water. In some embodiments, the material exhibits repellency to biological fluids. In some embodiments, the biological fluid is selected from the group consisting of whole blood, plasma, serum, sweat, feces, urine, saliva, tears, vaginal fluid, prostatic fluid, gingival fluid, amniotic fluid, intraocular fluid, cerebrospinal fluid, seminal fluid, sputum, ascites fluid, pus, nasopharengal fluid, wound exudate fluid, aqueous humour, vitreous humour, bile, cerumen, endolymph, perilymph, gastric juice, mucus, peritoneal fluid, pleural fluid, sebum, vomit, and combinations thereof.

In some embodiments, the material exhibits repellency to blood. In some embodiments, blood adhesion is decreased by about 93%. In some embodiments blood adhesion is determined by incubating materials in blood for about 20 minutes, then placing the materials into deionized water to allow blood adhered to the surface to mix into water by shaking the materials in the water for about 30 minutes before removing the materials from the water and taking absorbance values of water to determine changes in the amount of blood (e.g. hemoglobin) present on each surface.

In some embodiments, the material exhibits repellency to liquids comprising biospecies. In some embodiments, biospecies include microorganisms such as bacteria, fungi, viruses or diseased cells, parasitized cells, cancer cells, foreign cells, stem cells, and infected cells. In some embodiments, biospecies also included biosepecies components such as cell organelles, cell fragments, proteins, nucleic acids vesicles, nanoparticles, biofilm, and biofilm components.

In some embodiments, the material exhibits repellency to bacteria and biofilm formation. In some embodiments, the surface exhibits repellency to bacteria and biofilm formation. In some embodiments, the bacteria are selected from one or more of gram-negative bacteria or gram-positive bacteria. In some embodiments, the bacteria are selected from one or more of Escherichia coli, Streptococcus species, Helicobacter pylori, Clostridium species and meningococcus. In some embodiments, the bacteria are gram-negative bacteria selected from one or more of Escherichia coli, Salmonella typhimurium, Helicobacter pylori, Pseudomonas aerugenosa, Neisseria meningitidis, Klebsiella aerogenes, Shigella sonnei, Brevundimonas diminuta, Hafnia alvei, Yersinia ruckeri, Actinobacillus actinomycetemcomitans, Achromobacter xylosoxidans, Moraxella osloensis, Acinetobacter lwoffi, and Serratia fonticola. In some embodiments, the bacteria are gram-positive bacteria selected from one or more of Listeria monocytogenes, Bacillus subtilis, Clostridium difficile, Staphylococcus aureus, Enterococcus faecalis, Streptococcus pyogenes, Mycoplasma capricolum, Streptomyces violaceoruber, Corynebacterium diphtheria and Nocardia farcinica. In some embodiments, the bacteria are Escherichia coli. In some embodiments, bacteria attachment is decreased by about 97.5%.

According to another aspect, provided is a device or article comprising the material described herein. In some embodiments, the device or article is selected from any healthcare and laboratory device, personal protection equipment and medical device. In some embodiments, the device or article is selected from a cannula, a connector, a catheter, a catheter, a clamp, a skin hook, a cuff, a retractor, a shunt, a needle, a capillary tube, an endotracheal tube, a ventilator, a ventilator tubing, a drug delivery vehicle, a syringe, a microscope slide, a plate, a film, a laboratory work surface, a well, a well plate, a Petri dish, a tile, a jar, a flask, a beaker, a vial, a test tube, a tubing connector, a column, a container, a cuvette, a bottle, a drum, a vat, a tank, a dental tool, a dental implant, a biosensor, a bioelectrode, an endoscope, a mesh, a wound dressing, a vascular graft, and a combination thereof. In some embodiments, the device or articles is selected from any article with a high-risk surface in hospital settings (e.g. surgical and medical equipment), food packaging (e.g. packaging of meat, produce, etc.), high contact surface in public locations (e.g. door knobs, elevator buttons, etc.) or wearable article (e.g. gloves, watches, etc.). In some embodiments, the device is a catheter or implant. In some embodiments, the device is used for cell culture.

In some embodiments, the material is on the surface of the device or article. In some embodiments, the material is used to modify the surface of a device or article, such as a pre-formed device or article including, but not limited to, any device or article listed above. In some embodiments, the material forms the surface of the device or article.

According to another aspect of the present disclosure, provided herein is a method of preparing a material having a surface with hierarchical structures, the method comprising:
a) obtaining a shrinkable polymer substrate,
b) activating the substrate by oxidation of a surface layer,
c) depositing at least one at least one polysiloxane layer on the surface at substantially consistent relative humidity, and
d) treating the material to form microscale wrinkles,
   wherein the resultant surface exhibits superhydrophobic properties.

According to another aspect of the present disclosure, provided herein is a method of preparing a material having a surface with hierarchical structures, the method comprising:
a) activating a shrinkable polymer substrate by oxidation,
b) depositing at least one polysiloxane layer on the shrinkable polymer substrate at substantially consistent relative humidity, and
c) treating the substrate under conditions to form microscale wrinkles and nanoscale features to obtain the material,
   wherein the material exhibits superhydrophobic properties.

According to another aspect of the present disclosure, provided herein is a method of preparing a material having a surface with hierarchical structures, the method comprising:
a) providing a shrinkable polymer substrate,
b) activating a surface layer of the substrate by oxidation,
c) depositing at least one polysiloxane layer on the activated surface layer at substantially consistent relative humidity, and
d) treating the substrate under conditions to form microscale wrinkles and nanoscale features to obtain the material,
   wherein the material exhibits superhydrophobic properties.

According to another aspect of the present disclosure, provided herein is a method of preparing a material having a surface with hierarchical structures, the method comprising:
a) activating a surface layer of a shrinkable polymer substrate by oxidation,
b) depositing at least one polysiloxane layer on the activated surface layer at substantially consistent relative humidity, and
c) treating the substrate under conditions to form microscale wrinkles and nanoscale features to obtain the material,
   wherein the material exhibits superhydrophobic properties.

In some embodiments, activating the substrate comprises introducing hydroxyl groups, in or on the substrate.

In some embodiments, activating the substrate comprises plasma treatment. In some embodiments, activating the substrate comprises oxygen plasma treatment.

In some embodiments, the plasma treatment is for a time of about 30 seconds to about 10 minutes, or about 2 minutes to about 7 minutes, or about 3 minutes to about 5 minutes.

In some embodiments, the shrinkable polymer substrate is bi-directionally strained. In some embodiments, the method further comprises bi-directionally straining the shrinkable polymer substrate prior to activation.

In some embodiments, the shrinkable polymer substrate comprises polystyrene, polyolefin, polyethylene, polypropylene, and other shrinkable polymer or combinations and copolymers thereof. Examples of shrinkable polymers include but are not limited to polystyrene or polyolefin. For example, the term “shape memory polymer”, “shrinkable polymer” and “heat-shrinkable polymer” can refer to a polymer which is shrunk through subjecting the polymer to a temperature above its glass transition temperature. In some embodiments, the shrinkable polymer substrate comprises polystyrene, polyolefin, polyethylene, polypropylene, or combinations and copolymers thereof In some embodiments, the shrinkable polymer substrate is polyolefin.

In some embodiments, the relative humidity is substantially maintained at about 45% and about 65%, or about 50% to about 60%, or about 55%.

In some embodiments, the relative humidity is substantially maintained for about 4 hours to about 30 hours, or about 5 hours to about 24 hours, or about 6 hours. In some embodiments, the relative humidity is substantially maintained for the time to deposit the at least one polysiloxane layer.

In some embodiments, the at least one polysiloxane layer is formed using n-propyltrichlorosilane.

In some embodiments, the wrinkles are formed using suitable wrinkling process known in the art. In some embodiments, the wrinkling process is any process that creates microstructures in the material. In some embodiments, the wrinkling process-comprises exposing a compliant substrate modified with a stiff skin to compressive in-plane strain or when the substrate is subjected to the removal of tensile strain. The mismatch in the elastic moduli of the stiff layer and the compliant substrate results in the formation of wrinkles. In some embodiments, the microscale wrinkles are formed by heat-shrinking the material. In some embodiments, heat-shrinking is performed at a temperature of about 100° C. to about 200° C., about 120° C. to about 160° C. or about 140° C. to about 150° C., or about 145° C. In some embodiments, the heat-shrinking is performed for about 1 minute to about 15 minutes, or about 5 minutes to about 12 minutes, or about 10 minutes.

In some embodiments, the method may be used to modify the surface of a device or article, such as a pre-formed device or article including, but not limited to, any device or article listed above. In some embodiments, the device or article comprises the shrinkable polymer substrate.

In some embodiments, the method further comprises, after the depositing of the at least one polysiloxane layer on the activated surface layer, applying the substrate onto a surface of a device or article. In some embodiments, the substrate is wrapped on to at least a portion of the device or article after step c). In some embodiments, step d) is performed after wrapping to form a seal between the device or article and the material.

In some embodiments, the material is placed on a wide range of surfaces, such as high-risk surfaces in hospital settings (e.g. surgical and medical equipment), food packaging (e.g. packaging of meat, produce, etc.), high contact surfaces in public locations (e.g. door knobs, elevator buttons, etc.) or wearable articles (e.g. gloves, watches, etc.).

### EXAMPLES

The following non-limiting examples are illustrative of the present application:

### Methods

Reagents. n-Propyltrichlorosilane (98%) was purchased from Thermo Fisher Scientific (Whitby, Ontario, Canada). Sodium Bromide (99%) and silicone oils with varying viscosities (10, 20, 50, 100, 350, and 1000 cSt) were purchased from Sigma-Aldrich (Oakville, Ontario, Canada). Ethanol (anhydrous) was purchased from Greenfield (Brampton, Ontario, Canada). Deionized water was used to prepare solutions. Escherichia coli K-12 MG1655 transfected with pUA66-GadB green fluorescent protein was kindly donated by Dr. Eric Brown. LB broth powder was purchased from ThermoFisher Scientific (Whitby, ON). Agar was purchased from Bio-Rad. Kanamycin was purchased from Sigma-Aldrich (Oakville, ON). Venous human whole blood was collected in tubes containing sodium citrate from healthy donors by a licensed phlebotomist. All donors provided a written consent prior to donating blood. All procedures were approved by the McMaster University Research Ethics Board.

Preparation of Substrates. Polyolefin (Cryovac D-955) was cut into desired substrate sizes and shapes. Each substrate was washed with deionized water and ethanol, then dried with nitrogen gas. Three- or five-minute oxygen plasma treatment (Plasma Etch PE-100 Benchtop Plasma Etching System, Carson City, Nevada) was used to activate the surface of each substrate with hydroxyl groups.

Growth of Nanostructures. Following plasma treatment, substrates were coated with n-PTCS nanostructures. Samples were first placed inside a sealed chamber for a two-hour humidity stabilization period. Relative humidity was controlled using a super-saturated sodium bromide solution housed at the bottom of the chamber. After the desired RH (around 55%) was obtained, n-PTCS was added to the chamber through sealed rubber stoppers. Surface-initiated polymerization was allowed to proceed for varying times (6 hrs, 12 hrs, 18 hrs and 24 hrs) at room temperature.

Hierarchical Surfaces. Subsequent to coating, some samples were further modified using heat treatment. Substrates were placed on a silicon wafer inside an oven preheated to 145° C. for 10 minutes to induce wrinkling, resulting in hierarchical surfaces.

Lubricated Surfaces. In tests of lubricated conditions, substrates already coated with n-PTCS nanostructures, some of which were heat shrunk and some were not, were further treated with silicone oils of varying viscosities (10, 20, 50, 100, 350 and 100 cSt). Lubricant was added to the substrates for a two-hour incubation, then the substrate was held vertically for 24 hrs to remove excess oil. Surfaces in this condition were tested immediately following preparation in order minimize additional loss of lubricant.

Sliding and Contact Angle Measurements. Preliminary characteristics of each sample were analyzed using water contact and sliding angle measurements to investigate the wetting properties of the surfaces. Contact angle measurements of samples were obtained using a drop shape analyzer (Kruss DSA30S, Matthews, North Carolina). 2 μL droplets of water were dispensed from the needle and instrument software was used to measure the sessile drop contact angle. Sliding angle measurements were made using a calibrated digital angle level (ROK, Exeter, UK). 5 μL droplets were pipetted onto the sample and the level was tilted slowly until the droplet began to move. For high performing surfaces, droplets often skated across the surface not requiring any tilt to cause movement. These samples were assigned a sliding angle of 1°. In the case that the droplet did not move at 90° or greater, a sliding angle of 90° was assigned. A minimum of three measurements were repeated across the surface for both contact and sliding angle and the average±standard deviation was reported.

Scanning Electron Microscopy (SEM). In order to visualize the nanostructures formed on the surface, it was necessary to utilize electron microscopy (JEOL JSM-7000F, FEI Magellan 400). Samples were prepared as described above and cut to size before mounting to stubs using carbon tape and nickel paste, then coating with 10 nm of platinum using a sputter coater (Polaron model E1500, Polaron Equipment Ltd., Watford, Hertfordshire). SEM images were collected from a top-down view as well as side view for some samples, using 45° tilted stubs.

Stability Testing. Several stability tests were performed on hierarchical n-PTCS surfaces. To assess temperature effects, surfaces were stored at −20° C. and 37° C. for 24 hrs. Contact and sliding angle measurements were performed before and after incubation. The capacity of surfaces in withstanding ethanol was tested by incubating the surfaces in 100% ethanol for 1.5 hr, with contact angle used to assess performance. To confirm surface stability through washing with ethanol, hierarchical surfaces were subjected to a series of washes in ethanol using sonication. 7 mL of ethanol was added to a 15 mL falcon tube and a hierarchical surface was submerged. Contact and sliding angle measurements were obtained after sonication for 5, 10, and 15-minute periods. The ASTM scratch test was performed using the Elcometer 1542 Cross Hatch Adhesion Tester. Surfaces were scored with the cutter wheel twice with cuts at 90° to one another, debris was brushed off, then adhesive tape was applied to the surface and removed at 180° from surface. Performance was assessed by comparison to standardized documentation. To evaluate stability over time, surfaces were stored in petri dishes at room temperature and contact and sliding angle measurements were performed after 3, 4, and 5 months.

Whole Blood Droplet Experiment. Small squares (˜5 mm×5 mm) were cut from larger samples and placed in petri dishes humidified using Kimwipes dampened with DI water. A 5 μL droplet of citrated whole blood was placed on the surface of each sample. At timed intervals of 1, 5, 10, and 15 minutes, a Kimwipe® was used to gently wick away the droplet from the surface. Care was taken not to smear the fluid across the surface. Optical images were taken of surfaces using consistent lighting and distance from samples. Integrated density of the intensity in these images was quantified using ImageJ software. Images were first cropped to ensure equivalent regions of interest. Background was subtracted from the images, which were then converted to 8-bit and finally the threshold was set as 0-227. Software then calculated integrated density of these images. Standard deviation is reported with the average of these values, calculated from a minimum of 3 replicates for each condition. A two-way ANOVA was performed to determine significance.

Whole Blood Staining Assay. Samples were cut to 1 cm×1 cm squares and affixed to the bottom of a 24-well plate using double-sided tape. 500 μL of citrated whole blood was pipetted into each well and incubated for 20 minutes. Following incubation, surfaces were carefully removed from the well, ensuring tape was removed and the untreated side of the sample was clear of any blood. Samples were imaged optically then placed in a fresh well plate with wells containing 700 μL of DI water. Wells were shaken at 100 RPM for 30 minutes using a shaker (VWR Incubating Mini Shaker, Troemner, LLC, Thorofare, NJ) to detach any blood that had adhered to the surfaces. Surfaces were then removed and 200 μL of solution was pipetted into a fresh 96-well plate. Absorbance values were read at 450 nm using a plate reader (Synergy Neo2, BioTek, Winooski, Vermont). Relative absorbance values were calculated in reference to the control samples, planar PO. Values were reported as averages with standard deviation, obtained using a minimum of 3 replicates. A one-way ANOVA was used to determine significance.

Bacterial Adhesion Experiments. Surfaces were cut to size (˜15 mm diameter) and washed with 70% ethanol prior to use. 250 mL of LB broth was combined with 125 μL of Kanamycin to create 50 μg/mL LB-Kan media. A pipette tip was used to pick a single bacteria colony and inoculate the liquid media, the culture was incubated overnight at 37° C., shaken at 220 RPM. Overnight culture was separated into four 50 mL replicates and centrifuged at 4×g for 10 minutes. Supernatant was then discarded, and pellets were resuspended in 1 mL of fresh LB-Kan media to create the concentrated cell suspension for experimental use. Agar plugs were prepared by adding 300 ml of water to 9 g of agar, producing a 3% agar mixture, which was autoclaved and poured into polystyrene petri dishes to set. Agar plates were stored at 4° C. until use. Prior to beginning experimental procedure, agar plugs were cut to size to match the test surfaces (˜15 mm diameter). Bacteria was introduced to the plug by adding 20 μL of cell suspension, which was then gently spread across the agar using a pipette tip and allowed to incubate for five minutes. Test surfaces were stamped with these plugs and placed between two glass plates. Surfaces were imaged using the Amersham Typhoon imaging system (GE). Unstamped surfaces were used as controls for background fluorescence. Images were analysed using the ImageJ software, and fluorescence intensity was used to measure bacteria transfer onto the surfaces. Standard error of the mean was calculated for these samples using five replicates for each condition. A one-way ANOVA was used to calculate significance.

To directly quantify the number of bacteria transferred to the surfaces, the protocol above was slightly modified. Bacteria culture grown overnight was diluted to approximately 5.7×10\hat{ }⁷ CFU/mL and used instead of the concentrated cell suspension. The surfaces were stamped as explained above and then placed into 5 mL of LB-Kan media and mixed. Bacterial transfer onto the surfaces was measured by plating media from each stamped sample at various dilutions. In this case, 20 μL of media from the sample was combined with 180 μL of PBS in a 96-well plate with two replicate wells per sample. Dilutions up to 10-5 were created for each sample. 100 μL samples were plated in triplicate using a cell spreader and incubated overnight (37° C.). Plates were imaged using the ChemiDoc MP (BioRad) imaging system with the Blot/UV/Stain-Free Sample Tray and the Fluorescein setting. Images were analysed using the cell counter plugin in the ImageJ software. Standard error of the mean was calculated for these samples and a one-way ANOVA was used to determine significance.

### Results and Discussion

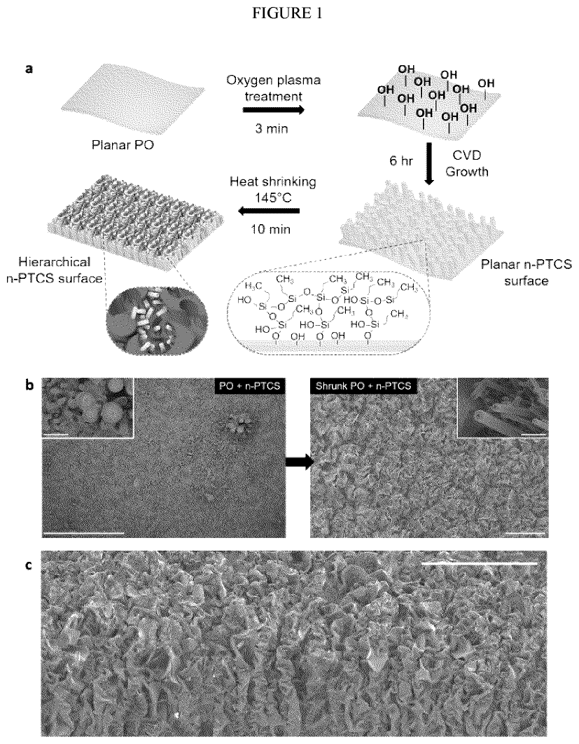

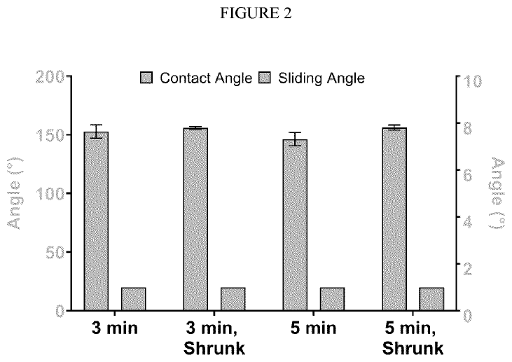

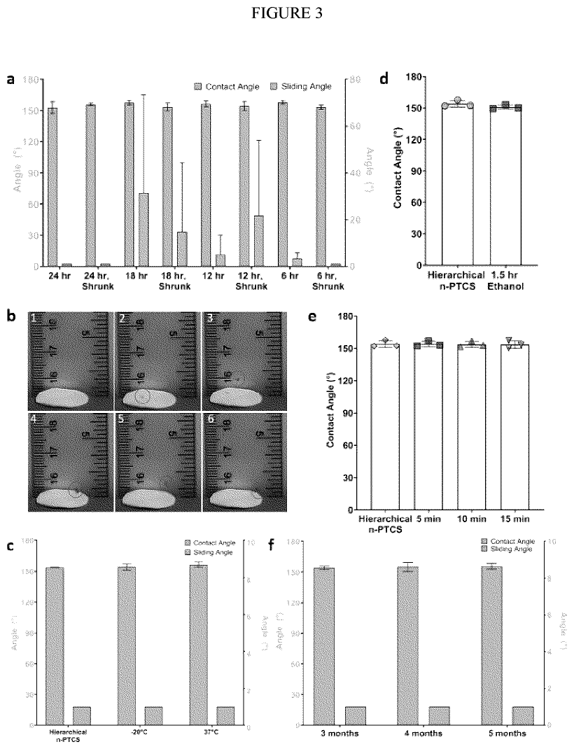

Fabrication and Characterization of Polysiloxane Hierarchical Surfaces. The hierarchical n-PTCS surfaces were fabricated using a three-step method. First, planar PO substrates (cut to desired size and shape) were activated through oxygen plasma treatment for 3 minutes. Next, a custom-made humidity chamber was employed for the growth of n-PTCS nanostructures on the PO surfaces (using chemical vapour deposition for 6-24 hours). Substrates are first placed in the customized humidity chamber for 2 hr to stabilize humidity at about 55% relative humidity (RH) and n-PTCS is then added through rubber stoppers. Finally, coated surfaces are wrinkled by being subjected to heat treatment at 145° C. for 10 minutes (FIG. 1). Bi-directionally strained polyolefin, a widely available heat shrinkable polymer film, was chosen as the substrate to ensure scalability. FIG. 2 shows optimization of the three-minute activation time to facilitate condensation reactions. The n-PTCS growth times were varied to optimize the structure of the hierarchical coating for maximal repellency (FIG. 3).

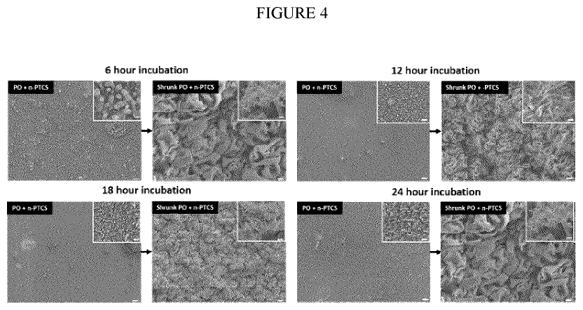

Each type of surface was characterized by measuring the contact and sliding angles (FIG. 3a) and was visualized using scanning electron microscopy (SEM) (FIG. 1b,c). The n-PTCS-treated surfaces demonstrated water contact angles >150° for both planar and hierarchical conditions, while sliding angles with water varied greatly on planar surfaces but consistently measured <15° on shrunk surfaces. Based on these results, a hierarchical surface after 6-hr incubation was selected as the highest performing surface (contact angle: 153° and sliding angle: <) 1° with the shortest growth duration. While planar n-PTCS surfaces performed similarly to hierarchical n-PTCS during these measurements, surface durability was markedly improved by structural hierarchy. Using light pressure to touch the surface of planar n-PTCS often resulted in significant residue from the surface being transferred. Additionally, small differences in coating thickness resulted in water droplets pinning to the planar n-PTCS surfaces during sliding angle measurements. Neither of these flaws were seen with hierarchical n-PTCS. On hierarchical n-PTCS surfaces, water droplets of 5 μL were observed to bounce or skate across the surface, demonstrating superhydrophobicity (FIG. 3b). Using slow motion recording of this phenomenon, it was seen that droplets would bounce twice on the surface, with the first bounce reaching a height of ˜0.5 cm. n-PTCS nanostructures are visible on the surface using microscopy prior to heat treatment and become integrated with wrinkles after the heat shrinking process (FIG. 1b,c). Variability was observed in density of nanostructures on planar surfaces however shrunk samples show wrinkling across the surface at all time points (FIG. 4). The n-PTCS nanostructures contain both filament and rod-like structures that in some instances resemble volcanos.¹³ n-PTCS nanostructures on PO are observed to range in diameter between hundreds of nanometers to over 1 μm in rare cases. This variability is shown across individual surfaces to some degree, as well as across different growth times. While the structures grown for 24 hrs appear more filamentous with diameters of about 200 nm, growing the structures for 6 hrs results in more rod-like structures with diameters of up to 1 μm (FIG. 4). Across growth times, some variability was also observed in the bidirectional micro-wrinkles created through shrinking, however all wrinkles, including those created from a 6-hr growth, were on the micrometer scale (FIG. 4).

To test the stability of these surfaces, environmental and physical tests were also conducted. Hierarchical n-PTCS surfaces placed in −20° C. or 37° C. environments for 24 hrs demonstrated no change in contact and sliding angle measurements (FIG. 3c). Incubation in 100% ethanol for 1.5 hr was also conducted. Once again, these surfaces maintained stable superhydrophobicity with no significant change in contact or sliding angle (FIG. 3d). Surfaces were also sonicated in 100% ethanol for increased durations, up to 15 minutes, without a significant loss in superhydrophobic characteristics (FIG. 3e). An ASTM International scratch test was performed on the hierarchical n-PTCS surface, which classifies adhesion strength from 0 to 5B, where 5B indicates ideal adhesion. A classification of 4B was measured for hierarchical n-PTCS, indicating that acceptable adhesion of the n-PTCS coating had been achieved. Finally, long term stability tests were performed for hierarchical n-PTCS with no loss of performance seen in contact or sliding angles after three, four and five months (FIG. 3f). All these results support the use of these hierarchical n-PTCS surfaces for use in high-touch and variable environments.

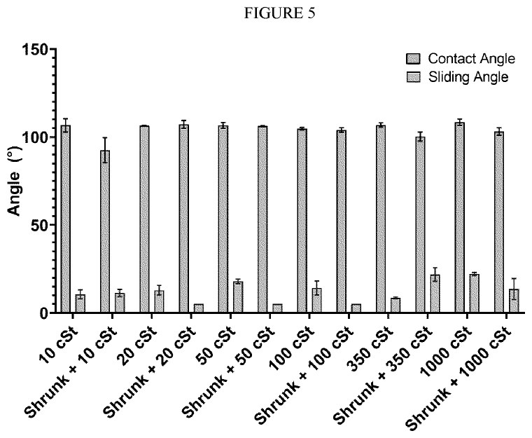

Reducing Blood Adhesion to Prevent Biofouling. To evaluate the performance of hierarchical n-PTCS surfaces in the presence of complex biofluids, preliminary characterization with citrated whole blood was performed to assess whether blood adheres to the surface. In this study, lubricated hierarchical n-PTCS surfaces were also included as a control to compare the performance of the lubricant-free approach with that of liquid-infused surfaces known to have excellent repellency and anti-biofouling properties. Since previous research has demonstrated the success of silicone oil as a lubricant for nanofilament coatings, 10 cSt, 20 cSt, 50 cSt, 100 cSt, 350 cSt and 1000 cSt silicone oil as lubricant for these surfaces was investigated to prepare a proper comparison for hierarchical surfaces. A silicone oil with 100 cSt was selected as the ideal viscosity based on sliding angle for both planar and shrunk samples, demonstrating a 5° water sliding angle and 104° water contact angle when added to hierarchical n-PTCS (FIG. 5).

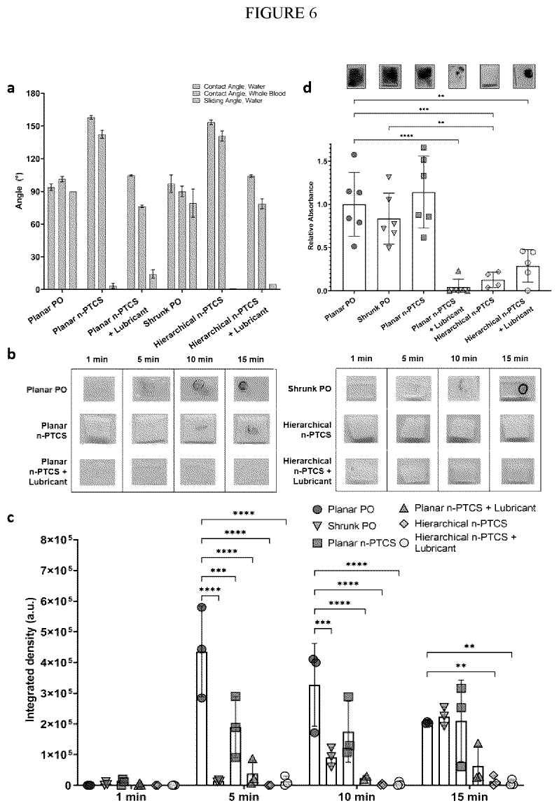

The contact angles with citrated whole blood on hierarchical n-PTCS surfaces) (140° were significantly higher than contact angles for planar or shrunk PO surfaces (FIG. 6a). This significantly exceeds blood contact angles measured on lubricated surfaces, while matching the contact angle on planar n-PTCS surfaces. A droplet staining test was also performed by incubating the surfaces in a humidity chamber for 15 min. The hierarchical n-PTCS surfaces remained visibly clean after the staining test, particularly in comparison to control groups of planar and shrunk PO (FIG. 6b). In order to quantify these results, the integrated density of intensity in images of each surface was measured. Intensity measurement trends aligned with visual evaluations, indicating that hierarchical n-PTCS surfaces significantly outperformed control conditions at all time points (FIG. 6c). Planar n-PTCS surfaces retain visible stains even after a 5-minute incubation with blood, highlighting the advantages of structural hierarchy in biorepellency. Performance of lubricant-free hierarchical n-PTCS surfaces was comparable to both planar and hierarchical lubricated surfaces, demonstrating the success of this hierarchical approach in eliminating the need for lubricant due to its on-par performance with these surfaces.

An additional staining test was also run. In this test, the surfaces were incubated in citrated whole blood for 20 minutes then gently removed and untreated sides of the sample were wiped clean. Surfaces were then placed in wells filled with DI water and shaken for 30 minutes to remove blood that had adhered to the surface. Measuring the relative absorbance of these wells illustrates once more the resistance of the hierarchical surfaces to staining, with a significant reduction between planar or shrunk PO and the hierarchical n-PTCS surfaces (FIG. 6d). Similar to the droplet study, the performance of the hierarchical n-PTCS was comparable to lubricated surfaces, showing no significant difference between planar or hierarchical lubricated n-PTCS. This successful reduction in surface staining signals high performance beyond visual cleanliness. Decreased blood adhesion minimizes potential for biofilm formation by bacterial species, as biofilms are known to be facilitated by the fibrinogen deposited by surface contamination with blood. This feature is particularly important for surfaces placed in healthcare facilities, which regularly become contaminated with blood while simultaneously being at risk of pathogen exposure.

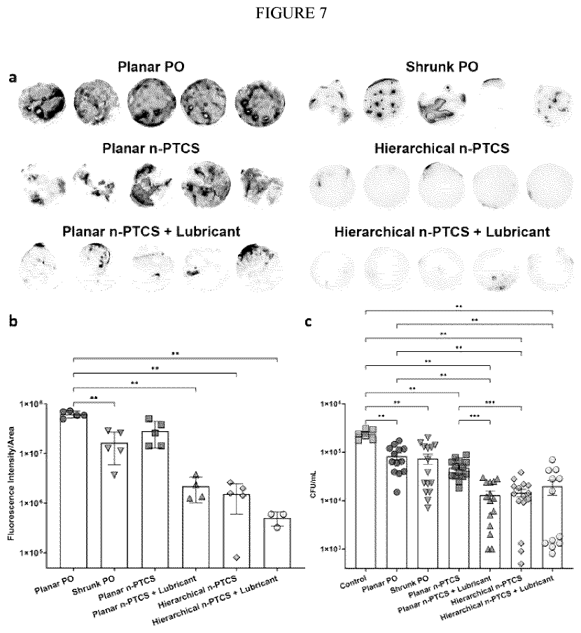

Preventing Pathogen Transfer to High-Touch Surfaces. To assess the pathogen repellency of these surfaces, an experiment was designed to mimic pathogen transfer to high-touch surfaces. The bacterial repellency of the surfaces was investigated using E. coli K-12 bacteria transfected with green fluorescent protein. E. coli is a robust and widely available gram-negative bacteria with lab-maintained strains such as K-12 documented to persist on surfaces due to adherent mutations. The surfaces were first stamped with E. coli-contaminated agar plugs, and bacterial adhesion was then quantified by measuring fluorescence intensity on the surfaces (FIG. 7a). The n-PTCS hierarchical surfaces demonstrated a 1.6-log (97.5%) reduction in bacterial load in comparison to planar PO, demonstrating the capability of these surfaces in resisting bacterial transfer (FIG. 7b). To compare the performance of the lubricant-free surfaces with their lubricated counterparts, the same series of samples used in the blood adhesion studies were fabricated and assessed. Like performance in complex biofluids, no significant differences were demonstrated between lubricated conditions and hierarchical n-PTCS. Further studies were performed to investigate the amount of live and growing bacteria transferred to the surfaces by the contaminated stamps. In this case, hierarchical n-PTCS surfaces exhibited a 1.2-log reduction (93%) in comparison to the control group, as shown in FIG. 7c. An 87% reduction is shown between planar PO and hierarchical n-PTCS, while no significant differences are demonstrated between lubricated planar n-PTCS or lubricated hierarchical n-PTCS and our ideal hierarchical n-PTCS. Together, these results indicate a significant resistance to surface contamination using the developed lubricant and fluorine-free hierarchical surfaces. Beyond this, the results also demonstrate no significant differences between the hierarchical n-PTCS surface and its lubricated hierarchical analogue. The hierarchical n-PTCS surface out-performed the lubricated planar n-PTCS surface (planar n-PTCS+lubricant) for this touch assay, as seen in FIG. 7b. This performance is in line with previous hierarchical surfaces produced on heat shrinkable surfaces, which demonstrated a 20-fold reduction in fluorescent signal using the same experimental design, however were manufactured using a fluorosilane coating. 1 Additionally, these surfaces perform consistently with previous investigations using polysiloxane nanostructures, which demonstrated significant reductions in bacterial adhesion to glass slides coated with n-PTCS and infiltrated with silicone oil lubricant. 11

While the present disclosure has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

### CITATIONS

(1) Imani, S. M.; Maclachlan, R.; Rachwalski, K.; Chan, Y.; Lee, B.; Mclnnes, M.; Grandfield, K.; Brown, E. D.; Didar, T. F.; Soleymani, L. Flexible Hierarchical Wraps Repel Drug-Resistant Gram-Negative and Positive Bacteria. ACS Nano 2020, 14 (1), 454-465. https://doi.org/10.1021/acsnano.9b06287.
(2) Lee, E.; Lee, K. H. Facile Fabrication of Superhydrophobic Surfaces with Hierarchical Structures. Sci. Rep. 2018, 8 (1), 4101. https://doi.org/10.1038/s41598-018-22501-8.
(3) Hassan, L. B.; Saadi, N. S.; Karabacak, T. Hierarchically Rough Superhydrophobic Copper Sheets Fabricated by a Sandblasting and Hot Water Treatment Process. Int. J. Adv. Manuf. Technol. 2017, 93 (1-4), 1107-1114. https://doi.org/10.1007/s00170-017-0584-7.
(4) Imani, S. M.; Maclachlan, R.; Chan, Y.; Shakeri, A.; Soleymani, L.; Didar, T. F. Hierarchical Structures, with Submillimeter Patterns, Micrometer Wrinkles, and Nanoscale Decorations, Suppress Biofouling and Enable Rapid Droplet Digitization. Small 2020, 16 (50), 1-9. https://doi.org/10.1002/smll.202004886.
(5) Jiang, R.; Hao, L.; Song, L.; Tian, L.; Fan, Y.; Zhao, J.; Liu, C.; Ming, W.; Ren, L. Lotus-Leaf-Inspired Hierarchical Structured Surface with Non-Fouling and Mechanical Bactericidal Performances. Chem. Eng. J. 2020, 398. https://doi.org/10.1016/j.cej.2020.125609.
(6) Artus, G. R. J.; Jung, S.; Zimmermann, J.; Gautschi, H. P.; Marquardt, K.; Seeger, S. Silicone Nanofilaments and Their Application as Superhydrophobic Coatings. Adv. Mater. 2006, 18 (20), 2758-2762. https://doi.org/10.1002/adma.200502030.
(7) Jin, M.; Li, S.; Wang, J.; Liao, M.; Zhao, Y. Controllable Fabrication of Organosilane Nano-Architectured Surfaces with Tunable Wettability. Appl. Surf. Sci. 2012, 258 (19), 7552-7555. https://doi.org/10.1016/j.apsusc.2012.04.084.
(8) Stojanovic, A.; Olveira, S.; Fischer, M.; Seeger, S. Polysiloxane Nanotubes. Chem. Mater. 2013, 25 (14), 2787-2792. https://doi.org/10.1021/cm400851k.
(9) Zimmermann, J.; Artus, G. R. J.; Seeger, S. Superhydrophobic Silicone Nanofilament Coatings. J. Adhes. Sci. Technol. 2008, 22 (3-4), 251-263. https://doi.org/10.1163/156856108X305165.
(10) Kasapgil, E.; Anac, I.; Erbil, H. Y. Transparent, Fluorine-Free, Heat-Resistant, Water Repellent Coating by Infusing Slippery Silicone Oil on Polysiloxane Nanofilament Layers Prepared by Gas Phase Reaction of n-Propyltrichlorosilane and Methyltrichlorosilane. Colloids Surfaces A Physicochem. Eng. Asp. 2019, 560 (September 2018), 223-232. https://doi.org/10.1016/j.colsurfa.2018.09.064.
(11) Kasapgil, E.; Badv, M.; Cantu, C. A.; Rahmani, S.; Yildirim Erbil, H.; Sakir, I. A.; Weitz, J. I.; Hosseini-Doust, Z.; Didar, T. F. Polysiloxane Nanofilaments Infused with Silicone Oil Prevent Bacterial Adhesion and Suppress Thrombosis on Intranasal Splints. ACS Biomater. Sci. Eng. 2021, 7 (2), 541-552. https://doi.org/10.1021/acsbiomaterials.0c01487.
(12) Meier, M.; Dubois, V.; Seeger, S. Reduced Bacterial Colonisation on Surfaces Coated with Silicone Nanostructures. Appl. Surf. Sci. 2018, 459 (July), 505-511. https://doi.org/10.1016/j.apsusc.2018.08.003.
(13) Artus, G. R. J.; Olveira, S.; Patra, D.; Seeger, S. Directed In Situ Shaping of Complex Nano- and Microstructures during Chemical Synthesis. Macromol. —Rapid Commun. 2017, 38 (4), 1-9. https://doi.org/10.1002/marc.201600558. (14) Li, B.; Cao, Y. P.; Feng, X. Q.; Gao, H. Mechanics of Morphological Instabilities and Surface Wrinkling in Soft Materials: A Review. Soft Matter 2012, 8 (21), 5728-5745. https://doi.org/10.1039/c2sm00011c.

1. A material comprising a shrinkable polymer substrate and at least one polysiloxane layer on a surface layer of the substrate, wherein the material comprises microscale wrinkles and nanoscale features that form hierarchical structures on a surface of the material, and wherein the material exhibits superhydrophobic properties.

2. The material of claim 1, wherein the shrinkable polymer substrate comprises polystyrene, polyolefin, polyethylene, polypropylene, and other shrinkable polymer or combinations and copolymers thereof.

3. (canceled)

4. The material of claim 1, wherein the shrinkable polymer substrate is bi-directionally strained.

5. The material of claim 1, wherein the nanoscale features comprise filament and/or rod-shaped structures.

6. The material of claim 1, wherein the at least one polysiloxane layer forms the nanoscale features.

7. (canceled)

8. The material of claim 1, wherein the at least one polysiloxane layer is formed using one or more compounds of the Formula II: 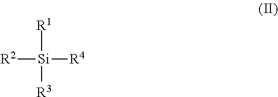
wherein R¹, R² and R³ are each independently a hydrolysable group; and R⁴ is C₁₋₆alkyl.

9. The material of claim 1, wherein the at least one polysiloxane layer is formed using n-propyltrichlorosilane.

10. The material of claim 1, wherein the at least one polysiloxane layer is not formed using a fluorosilane.

11. The material of claim 1, having a water static contact angle of about 150° to about 165° and having a water sliding angle of less than about 1.

12. (canceled)

13. The material of claim 1, wherein the material possesses antibacterial or antifouling properties or wherein the material exhibits repellency to biological fluids.

14. (canceled)

15. (canceled)

16. The material of claim 1, wherein the material exhibits repellency to liquids comprising biospecies or wherein the material exhibits repellency to bacteria and biofilm formation.

17. (canceled)

18. A device or article comprising the material of claim 1, optionally wherein the material is on the surface of the device or article.

19. (canceled)

20. A method of preparing a material having a surface with hierarchical structures, the method comprising:
a) activating a shrinkable polymer substrate by oxidation,
b) depositing at least one polysiloxane layer on the shrinkable polymer substrate at substantially consistent relative humidity,
c) treating the substrate under conditions to form microscale wrinkles and nanoscale features to obtain material,
wherein the material exhibits superhydrophobic properties.

21. The method of claim 20, wherein activating the surface layer of the substrate comprises introducing hydroxyl groups, in or on the substrate.

22. The method of claim 20 or 21, wherein activating the surface layer of the substrate comprises plasma treatment.

23. (canceled)

24. The method of claim 20, wherein the shrinkable polymer substrate provided in step a) is bi-directionally strained, optionally the method further comprises bi-directionally straining the substrate prior to the activating.

25. The method of claim 20, wherein the shrinkable polymer substrate is polyolefin.

26. The method of claim 20, wherein the relative humidity is maintained at about 45% and about 65%, or about 50% to about 60%, or about 55%, for about 4 hours to about 30 hours, or about 5 hours to about 24 hours, or about 6 hours.

27. (canceled)

28. The method of claim 20, wherein the at least one polysiloxane layer is formed using n-propyltrichlorosilane.

29. The method of claim 20, wherein the microscale wrinkles are formed by heat-shrinking the material.
